(19) United States
(12) Patent Application Publication
(10) Pub. No.: US 2016/0226233 A1
(43) Pub. Date: Aug. 4, 2016

(54) SIGNAL TRANSMISSION DEVICE

(71) Applicant: EZCONN CORPORATION, Taipei (TW)

(72) Inventor: Ming-Ching Chen, Taipei (TW)

(21) Appl. No.: 14/740,275

(22) Filed: Aug. 7, 2015

(30) Foreign Application Priority Data
Feb. 4, 2015 (TW) 104201824

(51) Int. Cl. H02G 13/00

(52) U.S. Cl. CPC H02G 13/80

(57) ABSTRACT

A signal transmission device includes a metal plate and a metal rod passing through a hole in the metal plate. A radial gap between the metal rod and an inner surface of the hole is between 0.1 millimeters and 0.6 millimeters. An electric current is configured to be discharged from the metal rod to the metal plate when a voltage difference between the metal plate and the metal rod is greater than or equal to 1 kV.

### BACKGROUND OF THE DISCLOSURE

1. Field of the Disclosure

The present disclosure relates to a signal transmission device, and more particularly to a signal transmission device having an anti-surge mechanism. The signal transmission device has a small volume and low cost.

2. Brief Description of the Related Art

Surge may result from two reasons: one reason is because of lightning that causes lightning surge; the other reason is because a circuit is being powered on to cause power surge. Lightning surge is generated by nature. When employed in an area prone to lightning, an overload protection circuit is necessary to be provided. For example, in order for protection from a lightning surge, a lightning protection device, voltage dependent resistor or capacitor may be employed. A lightning protection tube may be mounted to protect circuits and release the energy of lightning or overload from a power system so as to protect electronic equipment from being damaged due to an overvoltage. The lightning protection tube may cut off the electric current so as to prevent a system from being shorted to the electrical ground. Basically, the lightning protection tube couples between a live wire and the electrical ground and in parallel with the circuits to be protected. When the overvoltage is over a threshold voltage, the lightning protection tube may be actuated to have the electric current pass therethrough and to limit a voltage amplitude and thereby the electronic equipment may be protected. When the overvoltage is gone, the lightning protection tube is promptly recovered to ensure regular power supply to the system. However, the lightning protection tube has a high cost and large volume.

### SUMMARY OF THE DISCLOSURE

The present disclosure provides a signal transmission device with a metal plate sleeved around a signal terminal. An air radial gap exists between an annular surface of a hole in the metal plate and the signal terminal and acts as a surge protection structure. Comparing to the lightning protection tube or lightning protection element, the signal transmission device has a relatively low cost and small volume.

The present disclosure provides a signal transmission device. The signal transmission device includes a first metal plate; a first metal rod passing through a first hole in the first metal plate, wherein a first radial gap between the first metal rod and a first annular surface of the first hole is between 0.1 millimeters and 0.6 millimeters, wherein an electric current is configured to be discharged from the first metal rod to the first metal plate when a voltage difference between the first metal plate and the first metal rod is greater than or equal to 1 kV; and a circuit board connected to the first metal rod, wherein the circuit board comprises a first polymer layer, a patterned metal layer on the first polymer layer, and a second polymer layer on the first polymer layer and the patterned metal layer, wherein the patterned metal layer is connected to the first metal rod.

These, as well as other components, steps, features, benefits, and advantages of the present disclosure, will now become clear from a review of the following detailed description of illustrative embodiments, the accompanying drawings, and the claims.

### BRIEF DESCRIPTION OF THE DRAWINGS

The drawings disclose illustrative embodiments of the present disclosure. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same reference number or reference indicator appears in different drawings, it may refer to the same or like components or steps.

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure. In the drawings:

FIG. 1 is an exploded perspective view illustrating a surge protection device in accordance with a first embodiment of the present invention;

FIG. 2 is an exploded cross-sectional view illustrating the surge protection device in accordance with the first embodiment of the present invention;

FIG. 3 is a cross-sectional view illustrating a circuit board of the surge protection device in accordance with the first embodiment of the present invention;

FIGS. 4a, 4b 5 and 6 are cross-sectional views illustrating an assembly for the surge protection device in accordance with the first embodiment of the present invention;

FIG. 7 is a cross-sectional view illustrating a surge protection device in accordance with a second embodiment of the present invention;

FIG. 8a is a cross-sectional view illustrating a first type of surge protection device in accordance with a third embodiment of the present invention;

FIG. 8b is a cross-sectional view illustrating a second type of surge protection device in accordance with the third embodiment of the present invention;

FIG. 8c is a cross-sectional view illustrating a third type of surge protection device in accordance with the third embodiment of the present invention;

FIG. 9a is a cross-sectional view illustrating a first type of surge protection device in accordance with a fourth embodiment of the present invention;

FIG. 9b is a cross-sectional view illustrating a second type of surge protection device in accordance with the fourth embodiment of the present invention;

FIG. 9c is a cross-sectional view illustrating a third type of surge protection device in accordance with the fourth embodiment of the present invention;

FIG. 10a is a cross-sectional view illustrating a first type of surge protection device in accordance with a fifth embodiment of the present invention;

FIG. 10b is a cross-sectional view illustrating a second type of surge protection device in accordance with the fifth embodiment of the present invention;

FIG. 11a is a cross-sectional view illustrating a first type of surge protection device in accordance with a sixth embodiment of the present invention;

FIG. 11b is a cross-sectional view illustrating a second type of surge protection device in accordance with the sixth embodiment of the present invention;

FIG. 12a is a cross-sectional view illustrating a first type of surge protection device in accordance with a seventh embodiment of the present invention;

FIG. 12b is a cross-sectional view illustrating a second type of surge protection device in accordance with the seventh embodiment of the present invention;

FIG. 13a is a cross-sectional view illustrating a first type of surge protection device in accordance with a eighth embodiment of the present invention;

FIG. 13b is a cross-sectional view illustrating a second type of surge protection device in accordance with the eighth embodiment of the present invention;

FIG. 14 is a cross-sectional view illustrating a surge protection device in accordance with a ninth embodiment of the present invention; and

FIG. 15 is a cross-sectional view illustrating a surge protection device in accordance with a tenth embodiment of the present invention.

While certain embodiments are depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION OF THE INVENTION

Illustrative embodiments are now described. Other embodiments may be used in addition or instead. Details that may be apparent or unnecessary may be omitted to save space or for a more effective presentation. Conversely, some embodiments may be practiced without all of the details that are disclosed. When the same reference number or reference indicator appears in different drawings, it may refer to the same or like components or steps.

The present disclosure provides a signal transmission device that may be installed on an electronic device, such as signal filter, signal receiver, signal transmitter, signal attenuator or any one that needs to be protected from surge. Multiple embodiments are introduced in the following paragraphs.

### First Embodiment

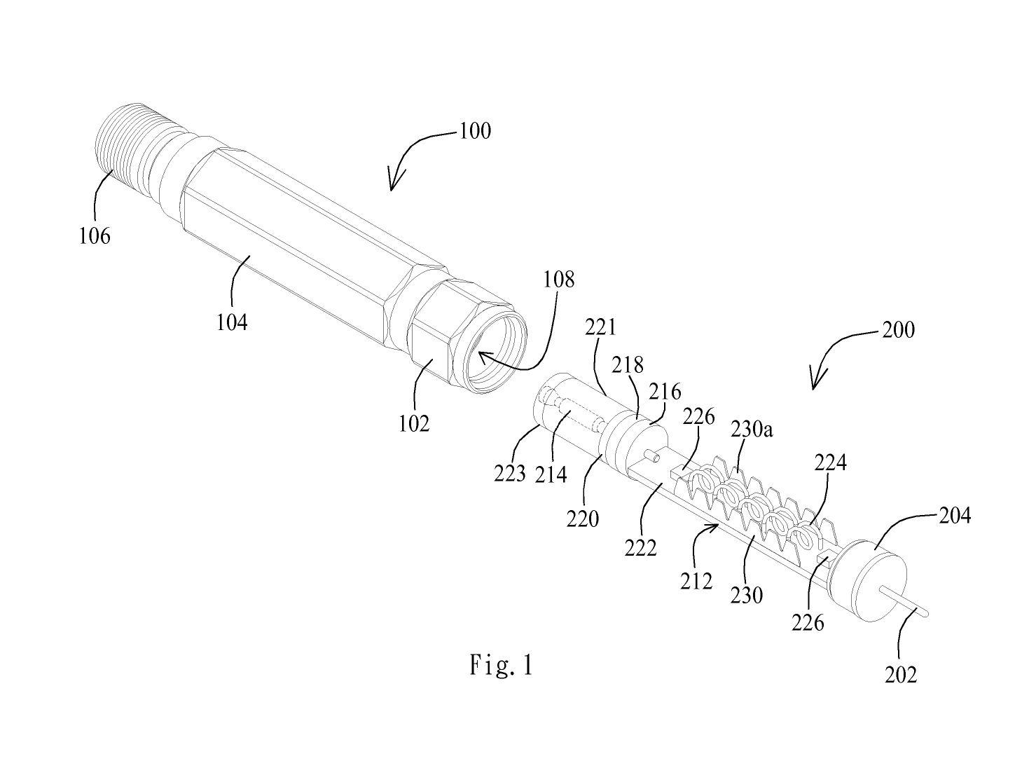

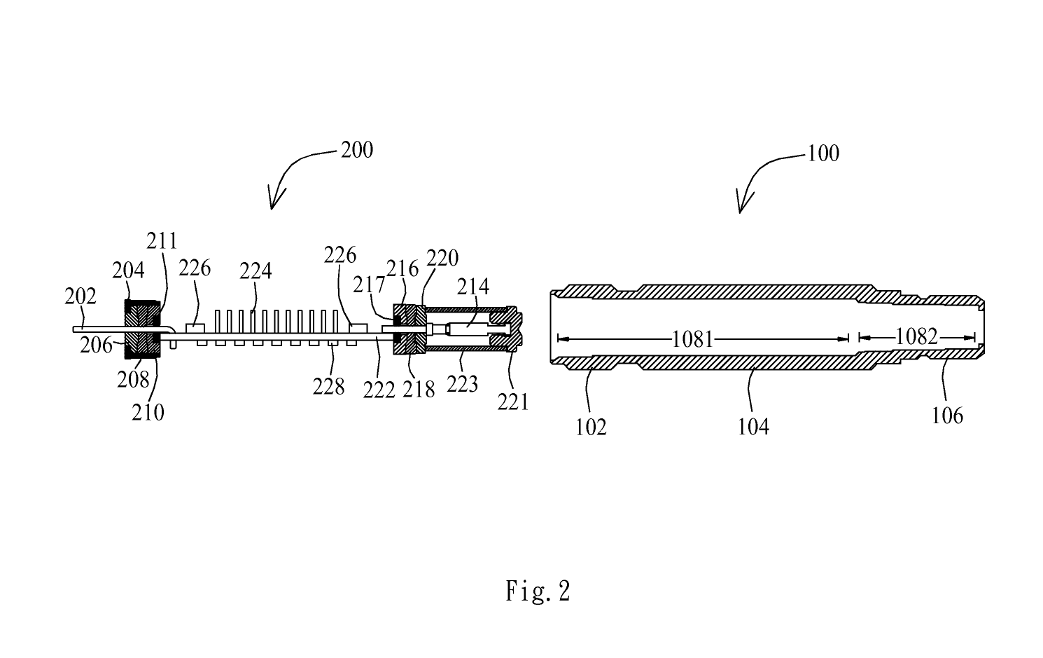

In accordance with the first embodiment, a signal filter is illustrated as an example. Referring to FIGS. 1 and 2, an electronic device includes a cylindrical housing 100 and an inner electronic assembly 200 accommodated in the cylindrical housing 100. The cylindrical housing 100 includes a nut portion 102 at a back end of the cylindrical housing 100, an outer-thread portion 106 at a front end of the cylindrical housing 100 and a main body 104 between the nut portion 102 and outer-thread portion 106. A through hole 108 passing through the cylindrical housing 100 may be divided into a first cylindrical space 1081 and a second cylindrical space 1082. The first cylindrical space 1081 has an inner diameter greater than that of the second cylindrical space 1082. The cylindrical housing 100 may be made of copper, iron, silver, nickel, tin, gold, copper-gold alloys, a copper-tin alloys, copper-nickel alloys, brass, brass alloys, phosphor bronze, beryllium copper, aluminum, aluminum alloys, zinc alloys, steel alloys or conductive polymers. The cylindrical housing 100 may be composed of the main body 104, nut portion 102 and outer-thread portion 106a formed as a single integral part.

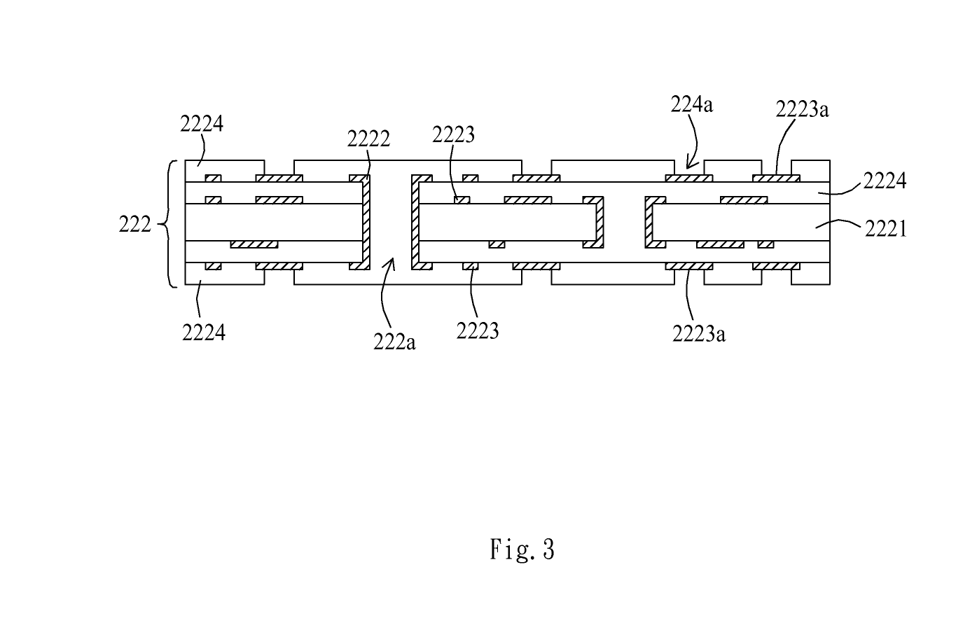

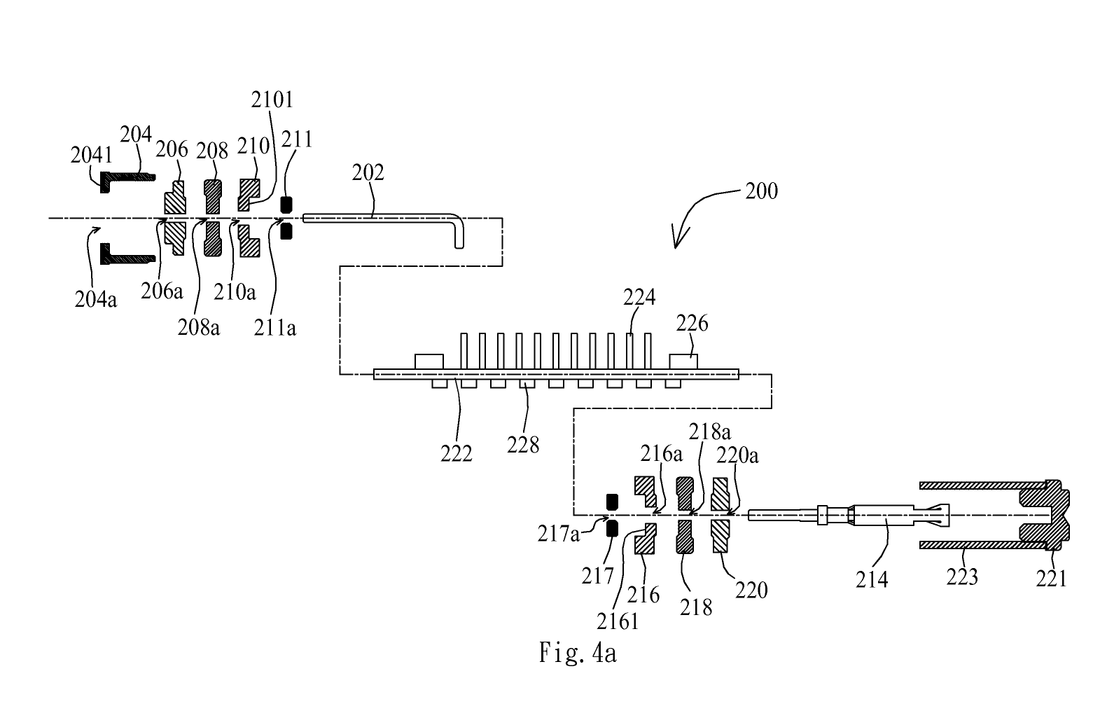

Referring to FIGS. 1 and 2, the inner electronic assembly 200 includes a first signal terminal 202, a metal sleeve 204, a first insulating annular plate 206, a first water-proof insulating annular plate 208, a first surge-protection metal annular plate 210, a second insulating annular plate 211, a circuit device 212, a second signal terminal 214, a second surge-protection metal annular plate 216, a third insulating annular plate 217, a second water-proof insulating annular plate 218, a fourth insulating annular plate 220, a fixing plate 221 and a fixing sleeve 223. The circuit device 212 includes a circuit board 222, multiple inductor coils 224, two capacitors 226, multiple resistors 228 and two metal sheets 230, wherein the circuit board 222 may be a printed circuit board with a rectangular shape having two parallel longer edges and two parallel shorter edges. Referring to FIG. 3, the circuit board 222 may include a core substrate 2221 having multiple through holes 222a pass therethrough, multiple patterned metal layers 2222 and 2223, such as copper or aluminum layers each having a thickness between 3 and 80 micrometers, and preferably between 3 and 50 micrometers, between 5 and 30 micrometers or between 10 and 80 micrometers, on an annular surface of each through holes 222a, over a top surface of the core substrate 2221 and under a bottom surface of the core substrate 2221, and multiple insulating polymer layers 2224 over the top surface of the core substrate 2221 and under the bottom surface of the core substrate 2221. In this case, two of the patterned metal layers 2223 and three of the insulating polymer layers 2224 are formed over the top surface of the core substrate 2221; two of the patterned metal layers 2223 and three of the insulating polymer layers 2224 are formed under the bottom surface of the core substrate 2221. The patterned metal layer 2222 in the through holes 222a may connect the patterned metal layers 2223 over the top surface of the core substrate 2221 and those under the bottom surface of the core substrate 2221. The patterned metal layers 2223 may include multiple metal pads 2223a exposed by multiple openings 224a in the topmost and bottommost ones of the insulating polymer layers 2224. A tin-containing solder may join the inductor coils 224, capacitors 226, resistors 228, metal sheets 230, first signal terminal 202 and second signal terminal 214 to the metal pads 2223a.

Referring to FIGS. 1, 2 and 3, the first signal terminal 202 may be shaped like a metal wire or rod, having a diameter between 0.5 mm and 1.5 mm, and preferably between 0.5 mm and 1 mm or between 0.7 mm and 1.5 mm, bent with a horizontally-extending portion and a vertically-extending portion joining the horizontally-extending portion at a right angle. The vertically-extending portion of the first signal terminal 202 may be inserted into a through hole in the circuit board 222 and join the circuit board 222 by a tin-containing solder so as to connect with the patterned metal layers 2223. The horizontally-extending portion of the first signal terminal 202 may pass across one of the shorter edges of the circuit board 222. The second signal terminal 214 may include a metal wire or rod, having a diameter between 0.5 mm and 1.5 mm, and preferably between 0.5 mm and 1 mm or between 0.7 mm and 1.5 mm, passing across the other one of the shorter edges of the circuit board 222 to join one of the metal pads 2223a exposed by one of the openings 224a via a tin-containing solder, and a metal socket joining the metal wire or rod of the second signal terminal 214 for engaging with a metal wire or rod of a signal terminal, like the first signal terminal 202, of another signal filter. The metal socket of the second signal terminal 214 may have an outer diameter, between 0.6 mm and 2.5 mm and preferably between 0.6 mm and 1.2 mm or between 0.8 and 2.5 mm, greater than a diameter of metal rod of first signal terminal 202. The two metal sheets 230 may be mounted along the two respective longer edges of the circuit board 222. Each of the metal sheets 230 may have a serrated portion 230a upwards extending from a corresponding one of the two longer edges of the circuit board 222 arranged in a horizontal level. Each of the metal sheets 230 may have a thickness between 0.02 mm and 2 mm, and preferably between 0.02 mm and 1 mm or between 0.5 mm and 2 mm. Each of the metal sheets 230 may be made of copper, iron, silver, nickel, tin, gold, copper-gold alloys, a copper-tin alloys, copper-nickel alloys, brass, brass alloys, phosphor bronze, beryllium copper, aluminum, aluminum alloys, zinc alloys or steel alloys. Each of the metal sheets 230 may be connected to the electrical ground of the circuit board 222. The inductor coils 224 and the capacitors 226 are mounted to the metal pads 2223a at a top surface of the circuit board 222 via a tin-containing solder, wherein the inductor coils 224 are mounted between the capacitors 226 in a longitudinal direction and between the metal sheets 230 in a transverse direction. The resistors 228 are mounted to the metal pads 2223a at the bottom surface of the circuit board 222. Two of the inductor coils 224, capacitors 226 and resistors 228 may be connected to each other via a combination of the metal pads 2223, patterned metal layers 2223 over and under the circuit board 222 and patterned metal layer 2222 in the through holes 222a.

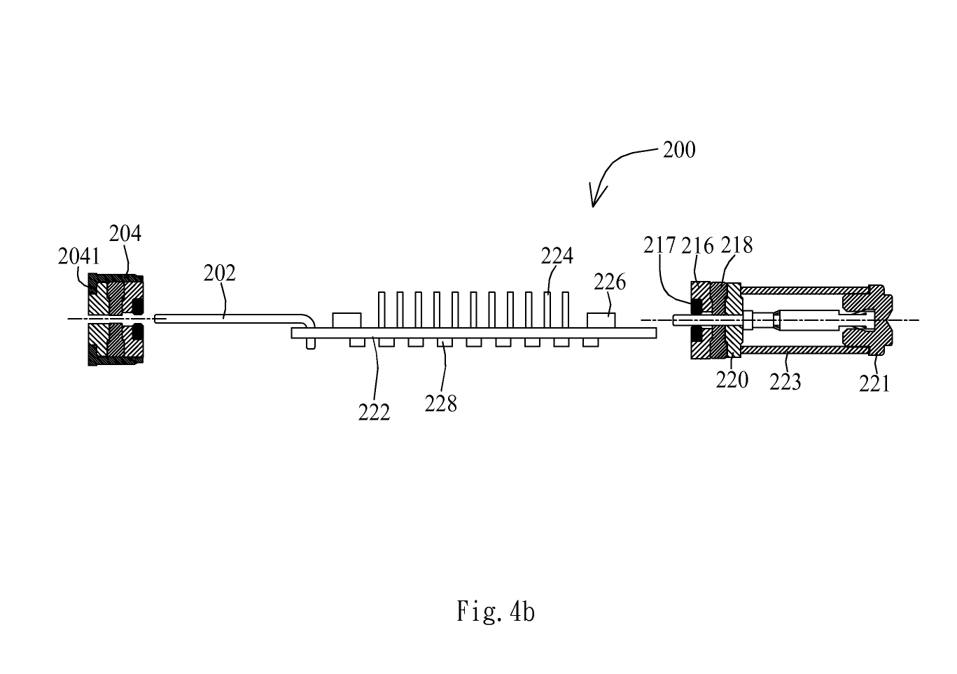

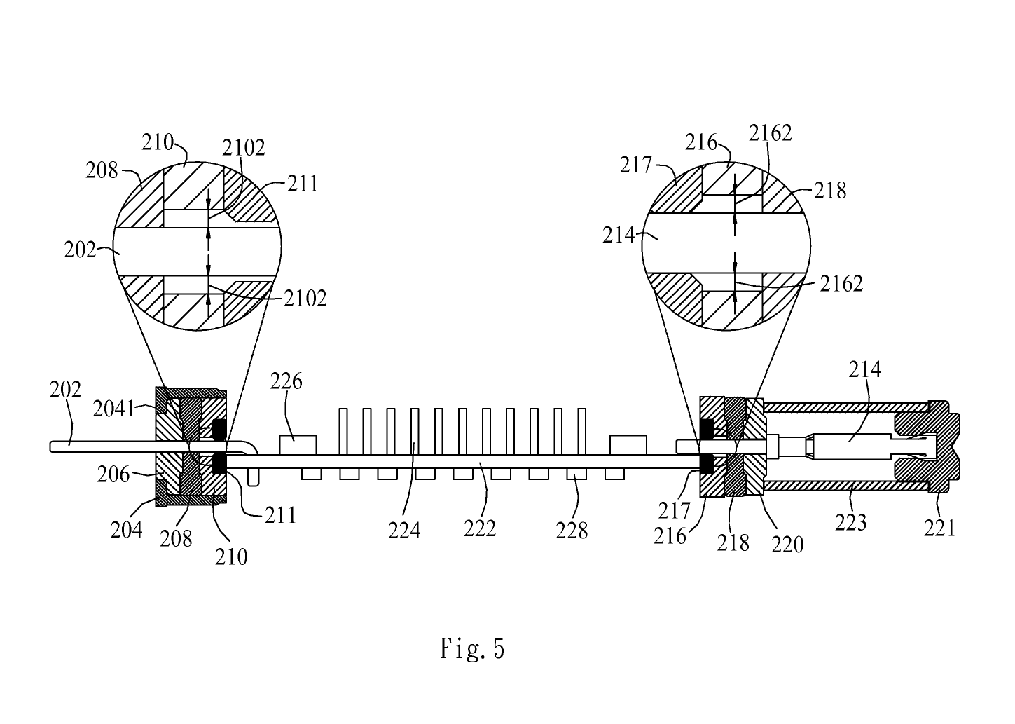

Referring to FIG. 4, the first insulating annular plate 206 may be inserted into a through hole 204a in the metal sleeve 204 until the first insulating annular plate 206 has a step abutting against a step 2041 of the metal sleeve 204. The first insulating annular plate 206 may have an annular periphery radially abutting against an annular surface of the through hole 204a in the metal sleeve 204. Next, the first water-proof insulating annular plate 208 may be inserted into the through hole 204a until the first water-proof insulating annular plate 208 abuts against the first insulating annular plate 206. The first water-proof insulating annular plate 208 may have an annular periphery radially abutting against an annular surface of the through hole 204a. Next, the first surge-protection metal annular plate 210 may be inserted into the through hole 204a until the first surge-protection metal annular plate 210 abuts against the first water-proof insulating annular plate 208. The first surge-protection metal annular plate 210 may have an annular periphery radially abutting against an annular surface of the through hole 204a. The second insulating annular plate 211 may be mounted to a step 2101 of the first surge-protection metal annular plate 210 before or after the first surge-protection metal annular plate 210 is mounted onto the first water-proof insulating annular plate 208 and into the through hole 204a. The second insulating annular plate 211 may have an annular periphery radially abutting against an annular surface of the step 2101 of the first surge-protection metal annular plate 210. The metal sleeve 204 may have an outer diameter substantially equal to an inner diameter of the through hole 108 in the first cylindrical space 1081 thereof. Each of the first and second insulating annular plates 206 and 211 may be made of a polymer, ceramic or glass material, such as plastic, polypropylene, polystyrene, polycarbonate, melamine resin or polytetrafluoroethene. The first water-proof insulating annular plate 208 may be made of a plastic, silicone, polymer elastomer or ceramic gasket. The first surge-protection metal annular plate 210 may be made of copper, iron, silver, nickel, tin, gold, copper-gold alloys, a copper-tin alloys, copper-nickel alloys, brass, brass alloys, phosphor bronze, beryllium copper, aluminum, aluminum alloys, zinc alloys or steel alloys.

Referring to FIG. 4, an axial through hole 206a in the first insulating annular plate 206 may have the same inner diameter, between 0.4 mm and 1.2 mm, and preferably between 0.4 mm and 0.9 mm or between 0.7 mm and 1.2 mm, as that of an axial through hole 211a in the second insulating annular plate 211 and as that of an axial through hole 208a in the first water-proof insulating annular plate 208. An axial through hole 210a in the first surge-protection metal annular plate 210 may have an inner diameter greater than that of the axial through hole 206a, that of the axial through hole 211a and that of the axial through hole 208a by between 0.3 mm and 1 mm and preferably between 0.3 mm and 0.9 mm or between 0.5 mm and 1 mm. The first surge-protection metal annular plate 210 may have an axial thickness between 0.5 mm and 3 mm, and preferably between 0.5 mm and 1.5 mm, between 1 mm and 2 mm or between 1.5 mm and 3 mm.

Besides, the second surge-protection metal annular plate 216 may have the same material as the first surge-protection metal annular plate 210. The third insulating annular plate 217 may have the same material as the second insulating annular plate 211. The second water-proof insulating annular plate 218 may have the same material as the first water-proof insulating annular plate 208. The fourth insulating annular plate 220 may have the same material as the first insulating annular plate 206. The third insulating annular plate 217 may be mounted to a step 2161 of the second surge-protection metal annular plate 216 and may have an annular periphery radially abutting against an annular surface of the step 2161 of the second surge-protection metal annular plate 216. Each of the second surge-protection metal annular plate 216, second water-proof insulating annular plate 218 and fourth insulating annular plate 220 may have an outer diameter substantially equal to an inner diameter of the through hole 108 in the second cylindrical space 1082 thereof, to an outer diameter of the first insulating annular plate 206, to an outer diameter of the first water-proof insulating annular plate 208 and to an outer diameter of the first surge-protection metal annular plate 210. An axial through hole 217a in the third insulating annular plate 217 may have the same inner diameter, between 0.6 mm and 1.8 mm, and preferably between 0.6 mm and 1 mm or between 0.8 mm and 1.8 mm, as that of an axial through hole 220a in the fourth insulating annular plate 220 and as that of an axial through hole 218a in the second water-proof insulating annular plate 218. Each of the axial through holes 217a, 220a and 218a may have an inner diameter greater than that of the axial through hole 206a, that of the axial through hole 208a and that of the axial through hole 211a by between 0.3 mm and 1 mm, and preferably between 0.3 mm and 0.9 mm or between 0.5 mm and 1 mm.

The second surge-protection metal annular plate 216 may have an axial thickness between 0.5 mm and 3 mm, and preferably between 0.5 mm and 1.5 mm, between 1 mm and 2 mm or between 1.5 mm and 3 mm.

Referring to FIGS. 4a, 4b and 5, the inner electronic assembly 200 is assembled as illustrated in the following paragraphs. The vertically-extending portion of the first signal terminal 202 may be first inserted into a through hole in the circuit board 222 and join the circuit board 222 by a tin-containing solder so as to connect with the patterned metal layers 2223 of the circuit board 222. Next, the horizontally-extending portion of the first signal terminal 202 may be inserted sequentially into the axial through hole 211a in the second insulating annular plate 211, the axial through hole 210a in the first surge-protection metal annular plate 210, the axial through hole 208a in the first water-proof insulating annular plate 208, and the axial through hole 206a in the first insulating annular plate 206 after the first insulating annular plate 206, first water-proof insulating annular plate 208, first surge-protection metal annular plate 210 and second insulating annular plate 211 are mounted into the through hole 204a in the metal sleeve 204. Each of the axial through holes 206a, 211a and 208a may have substantially the same inner diameter as the diameter of the horizontally-extending portion of the first signal terminal 202. The axial through holes 210a in the first surge-protection metal annular plate 210 may have an inner diameter greater than the diameter of the horizontally-extending portion of the first signal terminal 202 such that a first radial air gap 2102 may be formed between a cylindrical surface of the first signal terminal 202 and an annular surface of the axial through hole 210a, wherein the first radial air gap 2102 may be between 0.05 mm and 0.8 mm, and preferably between 0.1 mm and 0.6 mm or between 0.15 mm and 0.5 mm. The first radial air gap 2102 may be formed as a first discharging structure.

Next, a second discharging structure may be formed as illustrated in the paragraph. The third insulating annular plate 217 is mounted to the step 2161 of the second surge-protection metal annular plate 216 at a left side thereof and has an annular periphery radially abutting against the annular surface of the step 2161 of the second surge-protection metal annular plate 216. Next, the second water-proof insulating annular plate 218 is mounted onto a right side of the second surge-protection metal annular plate 216. Next, The fourth insulating annular plate 220 is mounted onto a right side of the second water-proof insulating annular plate 218. Next, the second signal terminal 214 may have the metal wire or rod to be inserted sequentially into the axial through hole 220a in the fourth insulating annular plate 220, the axial through hole 218a in the second water-proof insulating annular plate 218, the axial through hole 216a in the second surge-protection metal annular plate 216 and the axial through hole 217a in the third insulating annular plate 217. Each of the axial through holes 217a, 218a and 220a may have substantially the same inner diameter as the diameter of the metal wire or rod of the second signal terminal 214. The axial through holes 216a in the second surge-protection metal annular plate 216 may have an inner diameter greater than the diameter of the metal wire or rod of the second signal terminal 214 such that a second radial air gap 2162 may be formed between the metal wire or rod of the second signal terminal 214 and an annular surface of the axial through hole 216a, wherein the second radial air gap 2162 may be between 0.05 mm and 0.8 mm, and preferably between 0.1 mm and 0.6 mm or between 0.15 mm and 0.5 mm. The second radial air gap 2162 may be formed as the second discharging structure. Next, a tin-containing solder may be formed to join the metal wire or rod of the second signal terminal 214 to the metal pads 2223a of the circuit board 222, and thereby the second signal terminal 214 may be electrically connected to the patterned metal layers 2223 of the circuit board 222 via the tin-containing solder. Next, the second signal terminal 214 may have the metal socket to be inserted into a through hole in the fixing sleeve 223 from a front end thereof, wherein the fixing sleeve has a back end mounted to the fixing plate 221, until the fourth insulating annular plate 220 abuts against the front end of the fixing sleeve 223 and the metal socket of the second signal terminal 214 is inserted into and engaged with the an axial through hole 221 a in the fixing plate 221. Alternatively, the first and second water-proof insulating annular plates 208 and 218 and the second and third insulating annular plates 211 and 217 may be saved.

Next, referring to FIGS. 1, 2 and 6, the inner electronic assembly 200 may be mounted into the through hole 108 in the cylindrical housing 100. In this step, each of the serrated portions 230a of the metal sheets 230 mounted on the circuit board 222 may be inwardly bent in an arc between 0.1 π and 0.45 π, and preferably between 0.1 π and 0.25 π, between 0.15 π and 0.33 π or between 0.2 π and 0.45 π. Preferably, each of the serrated portions 230a of the metal sheets 230 may have substantially the same curvature radius as that of an annular surface of the through hole 108.

Next, the inner electronic assembly 200 with its second signal terminal 214 is inserted into the through hole 108 in the cylindrical housing 100 in a direction from its nut portion 102 to its outer-thread portion 106. Due to each of the second surge-protection metal annular plate 216, second water-proof insulating annular plate 218 and fourth insulating annular plate 220 having an outer diameter less than an inner diameter of the through hole 108 in the first cylindrical space 1081, the second surge-protection metal annular plate 216, second water-proof insulating annular plate 218 and fourth insulating annular plate 220 may be moved in the through hole 108 from the first cylindrical space 1081 to the second cylindrical space 1082 and stop at the second cylindrical space 1082. At this time, the metal sleeve 204 may be moved in the first cylindrical space 1081 and the serrated portions 230a of the two metal sheets 230 may surface-to-surface contact the annular surface of the through hole 108. Next, the metal sleeve 204 may be tightly fitted with, riveted with or engaged with the first cylindrical space 1081 in the through hole 108, and the second surge-protection metal annular plate 216 may be tightly fitted with, riveted with or engaged with the second cylindrical space 1082 in the through hole 108 such that the inner electronic assembly 200 may be fixed in the through hole 108 in the cylindrical housing 100.

When the signal filter operates for signal processing, the first signal terminal 202 and the second signal terminal 214 may act as an input signal terminal and output signal terminal of the signal filter respectively or act as an output signal terminal and input signal terminal of the signal filter respectively. Taking an example of the first and second signal terminal 202 and 214 acting as an input signal terminal and output signal terminal of the signal filter respectively, when the signal filter operates for signal processing, lightning may occur to the signal filter such that a surge voltage between 1 kV and 8 kV or between 2 kV and 7 kV may be applied to the input signal terminal. At this time, a surge current may pass from the first signal terminal 202 to the first surge-protection metal annular plate 210 through the first radial air gap 2102 and then pass from the first surge-protection metal annular plate 210 to the electrical ground through the metal sleeve 204 and cylindrical housing 100. Thereby, the signal filter may be protected from the surge current. Taking an example of the first and second signal terminal 202 and 214 acting as an output signal terminal and input signal terminal of the signal filter respectively, when lightning occurs to the signal filter, a surge current may pass from the second signal terminal 214 to the second surge-protection metal annular plate 216 through the second radial air gap 2162 and then pass from the second surge-protection metal annular plate 216 to the electrical ground through the cylindrical housing 100.

When the surge current does not fully pass to the electrical ground through the first or second radial air gap 2102 or 2162, the remaining surge current may be received by the capacitors 226 mounted on the circuit board 222 coupled to the metal sheets 230 via the patterned metal layers 2223, wherein the metal sheets 230 surface-to-surface contact the annular surface of the through hole 108 in the cylindrical housing 100. Thereby, the remaining surge current may pass from the capacitors 226 to the electrical ground through the patterned metal layers 2223, metal sheets 230 and cylindrical housing 100. Alternatively, the capacitors 226 may be saved.

The present invention provides a surge-protection metal annular plate at an input signal terminal with a radial air gap between an annular surface of an axial through hole in the surge-protection metal annular plate and a cylindrical surface of the input signal terminal being formed to protect a surge current. Comparing to the conventional lightning protection tube or lightning protection element, the signal transmission device in accordance with the present invention has a relatively low cost and small volume.

### Second Embodiment

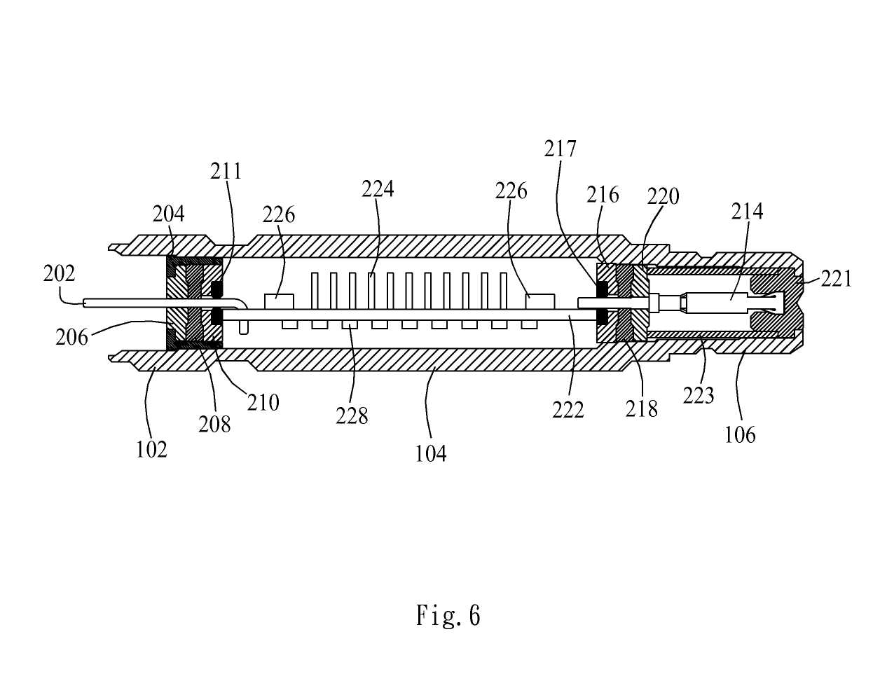

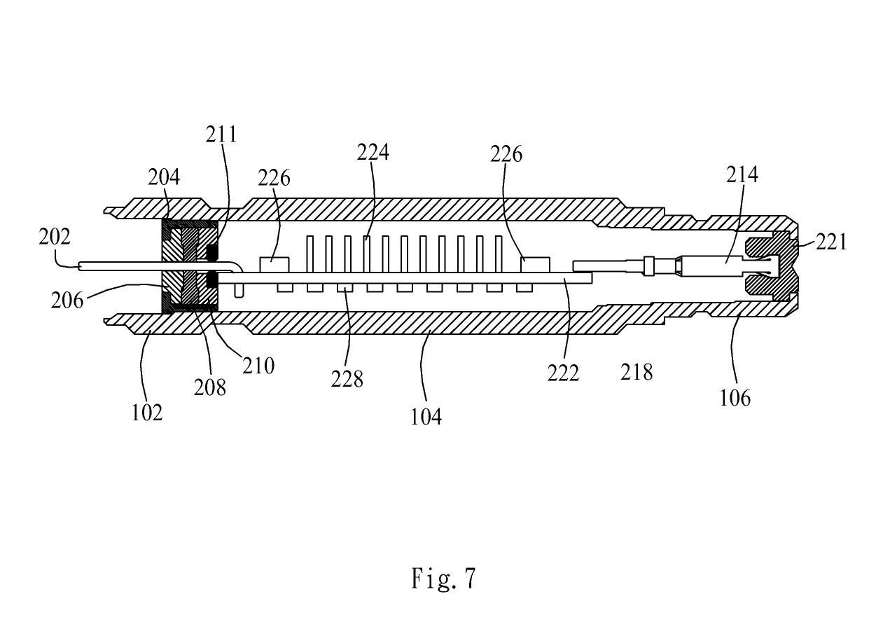

In the first embodiment, either of the first and second signal terminals 202 and 214 may act as an input signal terminal of the signal transmission device. For the purpose, the first discharging structure, i.e. the first radial air gap 2102, and the second discharging structure, i.e. the second radial air gap 2162, may be formed at the first and second signal terminals 202 and 214 respectively. However, in the second embodiment, one of the first and second signal terminals 202 and 214 may be regulated as an input signal terminal of the signal transmission device, and the other one of the first and second signal terminals 202 and 214 may be regulated as an output signal terminal of the signal transmission device. In this case, referring to FIG. 7, the first signal terminal 202 is regulated as an input signal terminal of the signal transmission device, and the second signal terminal 214 is regulated as an output signal terminal of the signal transmission device. For the purpose, the first discharging structure, i.e. the first radial air gap 2102, may be formed at the first signal terminal 202 and the second discharging structure, i.e. the second radial air gap 2162, may be saved. Alternatively, when first signal terminal 202 is regulated as an output signal terminal of the signal transmission device and the second signal terminal 214 is regulated as an input signal terminal of the signal transmission device, the second discharging structure, i.e. the second radial air gap 2162, may be formed at the second signal terminal 214 and the first discharging structure, i.e. the first radial air gap 2102, may be saved. The element, as illustrated in the second embodiment, indicated by the same reference number as that in the first embodiment may be referred to the illustration for that in the first embodiment.

### Third Embodiment

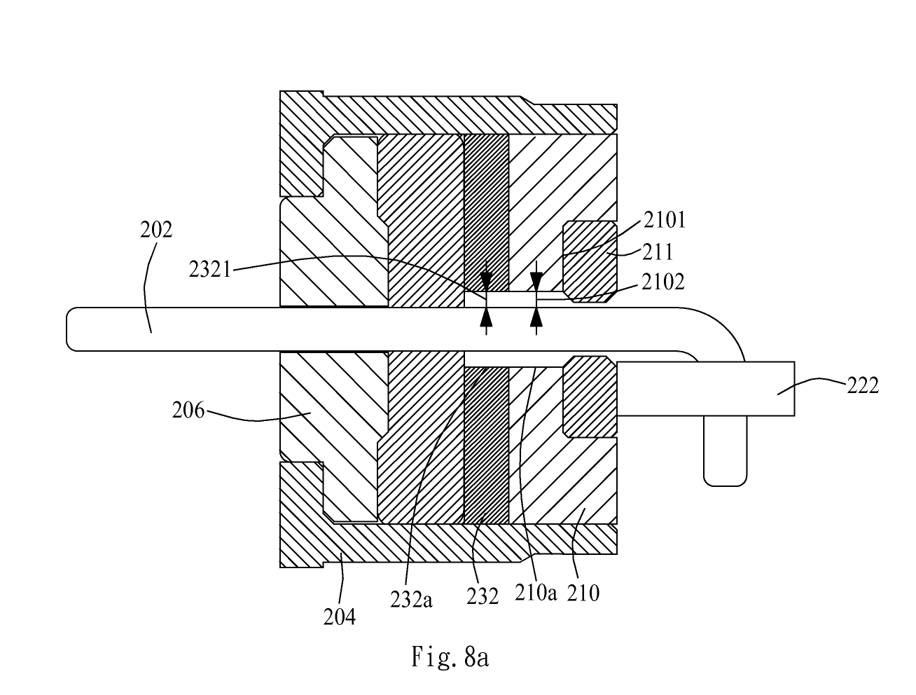

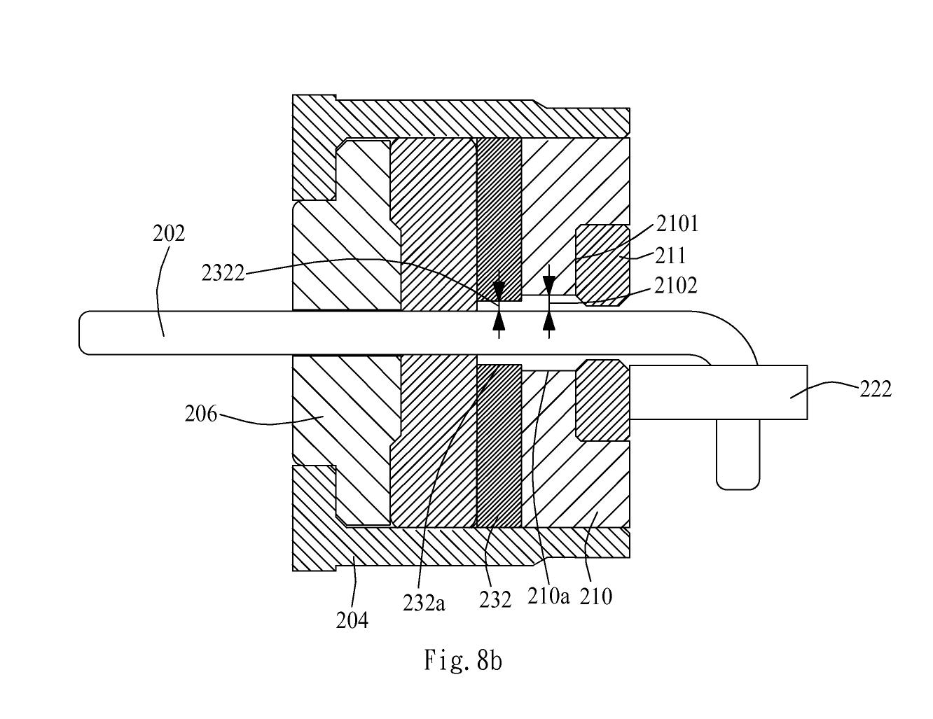

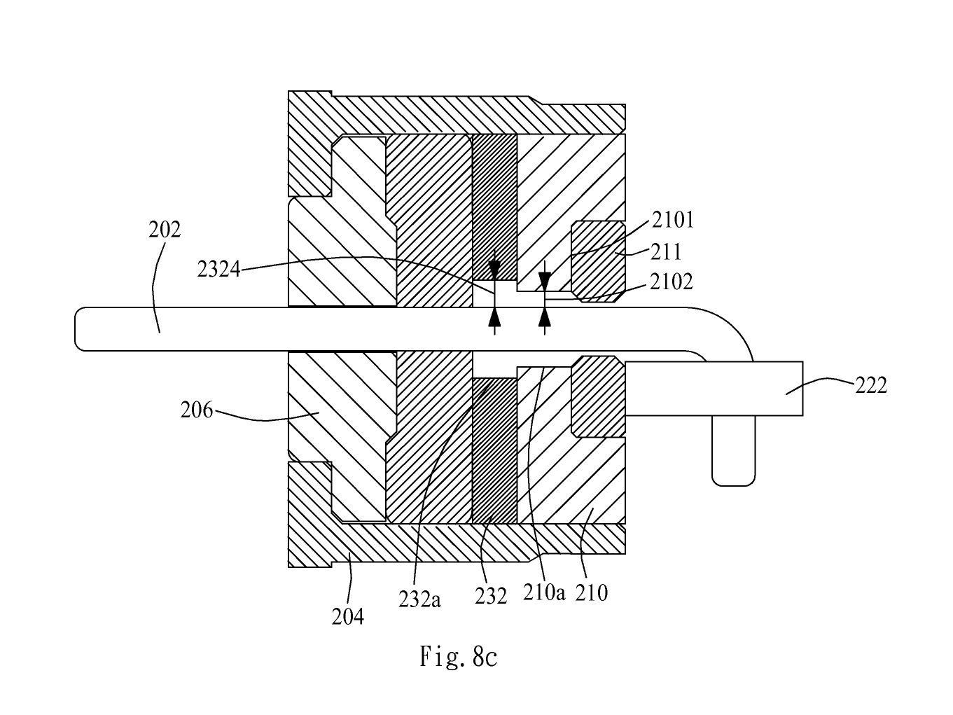

In the first and second embodiments, each of the first and second discharging structures is one-stage discharging structure. Alternatively, each of the first and second discharging structures may be modified into a two-stage discharging structure as shown in FIGS. 8a, 8b and 8c. The element, as illustrated in the third embodiment, indicated by the same reference number as that in the first embodiment may be referred to the illustration for that in the first embodiment. The two-stage discharging structure modified from the first discharging structure includes the first surge-protection metal annular plate 210 and a third surge-protection metal annular plate 232 axially between the first surge-protection metal annular plate 210 and the first water-proof insulating annular plate 208. The third surge-protection metal annular plate 232 may be made of materials as illustrated for composing the first surge-protection metal annular plate 210. The third surge-protection metal annular plate 232 may have the same material as that of the first surge-protection metal annular plate 210. Alternatively, the third surge-protection metal annular plate 232 may have different materials from that of the first surge-protection metal annular plate 210. An axial through hole 232a in the third surge-protection metal annular plate 232 may have an inner diameter between 0.4 mm and 1.2 mm, and preferably between 0.4 mm and 0.9 mm or between 0.7 mm and 1.2 mm.

In a first case as illustrated in FIG. 8a, the axial through hole 232a in the third surge-protection metal annular plate 232 may have the inner diameter substantially equal to that of the axial through hole 210a in the first surge-protection metal annular plate 210. A radial air gap 2321 between an annular surface of the axial through hole 232a in the third surge-protection metal annular plate 232 and a cylindrical surface of the first signal terminal 202 may be substantially equal to the first radial air gap 2102.

Alternatively, in a second case as illustrated in FIG. 8b, the axial through hole 232a in the third surge-protection metal annular plate 232 may have the inner diameter less than that of the axial through hole 210a in the first surge-protection metal annular plate 210. The difference between the inner diameter of the axial through hole 232a and that of the axial through hole 210a may be between 0.1 mm and 0.9 mm, and preferably between 0.1 mm and 0.3 mm, between 0.2 mm and 0.6 mm or between 0.3 mm and 0.9 mm. A third radial air gap 2322 between an annular surface of the axial through hole 232a in the third surge-protection metal annular plate 232 and a cylindrical surface of the first signal terminal 202 may be less than the first radial air gap 2102. The difference between the first and third air gaps 2102 and 2322 may be between 0.05 mm and 0.45 mm, and preferably between 0.05 mm and 0.15 mm, between 0.1 mm and 0.3 mm or between 0.15 and 0.45 mm.

Alternatively, in a third case as illustrated in FIG. 8c, the axial through hole 232a in the third surge-protection metal annular plate 232 may have the inner diameter greater than that of the axial through hole 210a in the first surge-protection metal annular plate 210. The difference between the inner diameter of the axial through hole 232a and that of the axial through hole 210a may be between 0.1 mm and 0.9 mm, and preferably between 0.1 mm and 0.3 mm, between 0.2 mm and 0.6 mm or between 0.3 mm and 0.9 mm. A fourth radial air gap 2324 between an annular surface of the axial through hole 232a in the third surge-protection metal annular plate 232 and a cylindrical surface of the first signal terminal 202 may be greater than the first radial air gap 2102. The difference between the first and fourth air gaps 2102 and 2324 may be between 0.05 mm and 0.45 mm, and preferably between 0.05 mm and 0.15 mm, between 0.1 mm and 0.3 mm or between 0.15 and 0.45 mm.

Alternatively, with regards to the second discharging structure, the third surge-protection metal annular plate 232 may be further arranged axially between the second surge-protection metal annular plate 216 and the second water-proof insulating annular plate 218. The defined radial air gaps 2321, 2322 and 2323 may be applied to a radial air gap between the annular surface of the axial through hole 232a in the third surge-protection metal annular plate 232 and the second signal terminal 214, which may be substantially equal to the second radial air gap 2162, or greater than or less than the second radial air gap 2162 with a difference between the annular surface of the axial through hole 232a and the second signal terminal 214 being between 0.05 mm and 0.45 mm, and preferably between 0.05 mm and 0.15 mm, between 0.1 mm and 0.3 mm or between 0.15 and 0.45 mm.

### Fourth Embodiment

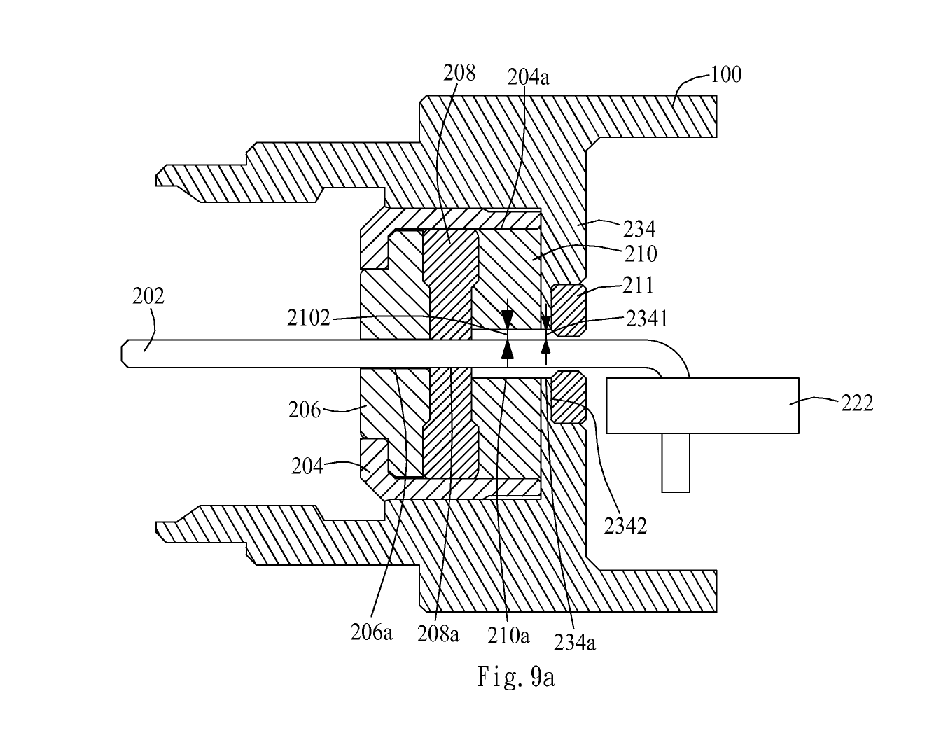

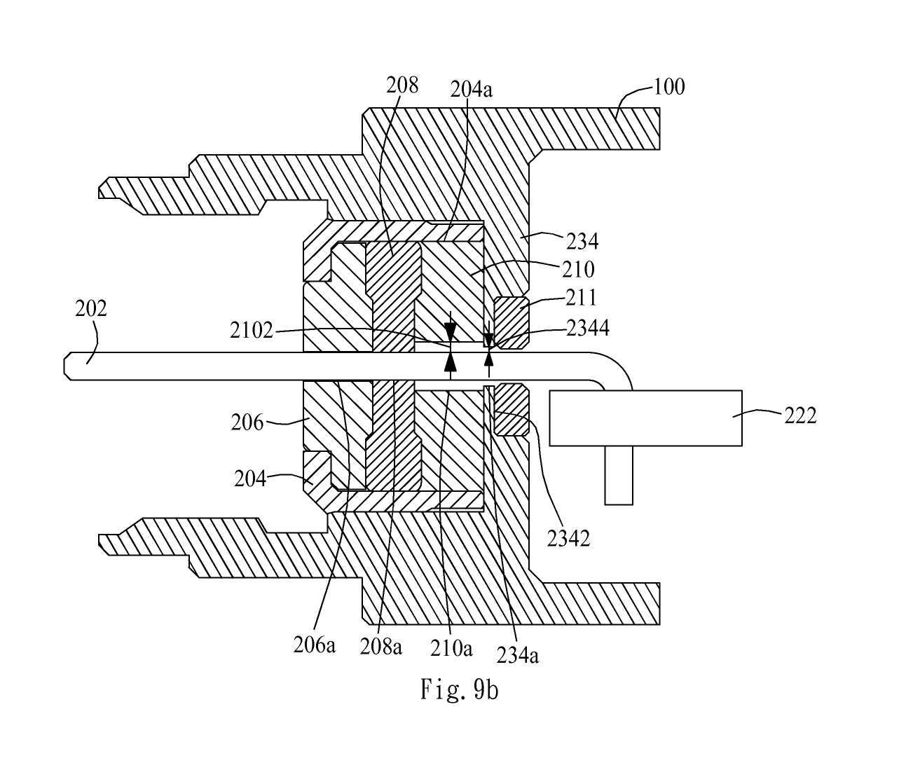

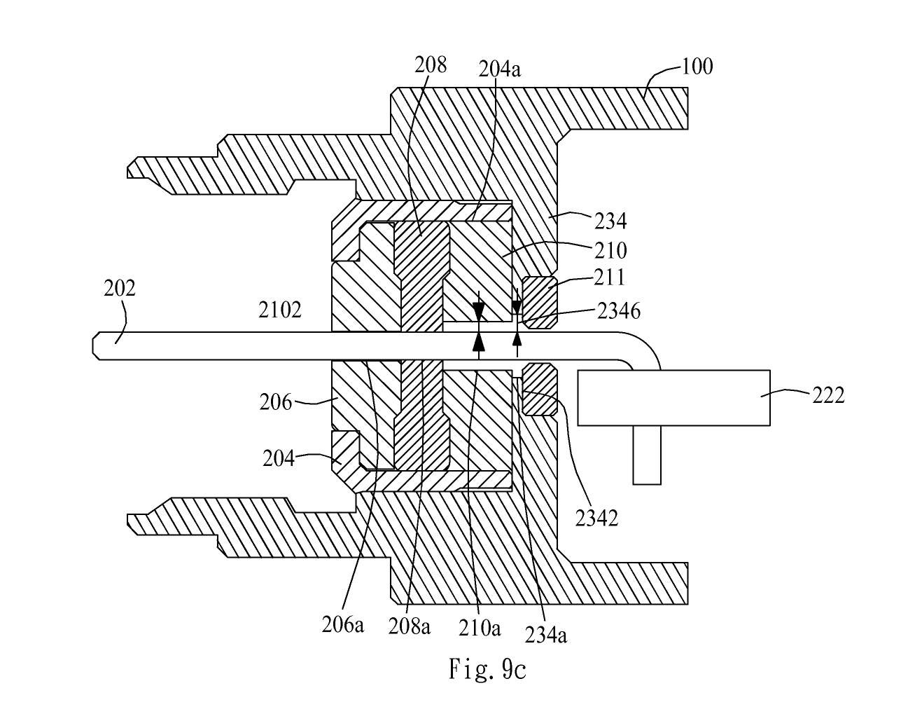

Referring to FIGS. 9a-9c, with regards to the first discharging structure, the difference between the third and fourth embodiments is that the cylindrical housing 100 in accordance with the fourth embodiment may be provided with a fourth surge-protection metal annular plate 234, instead of the third surge-protection metal annular plate 232 illustrated in the third embodiment, and the first surge-protection metal annular plate 210 in accordance with the fourth embodiment has no step, like the step 2101 shown in the third embodiment, having the second insulating annular plate 211 mounted thereto, but the second insulating annular plate 211 is mounted to a step 2342 of the fourth surge-protection metal annular plate 234. The fourth surge-protection metal annular plate 234 may be integral with the cylindrical housing 100 as a single part and protrude from the annular surface of the through hole 108 in the cylindrical housing 100. The fourth surge-protection metal annular plate 234 may have the same material as that of the cylindrical housing 100. An axial through hole 234a in the fourth surge-protection metal annular plate 234 may have an inner diameter between 0.4 mm and 1.2 mm, and preferably between 0.4 mm and 0.9 mm or between 0.7 mm and 1.2 mm.

Referring to FIGS. 9a-9c, the difference between the step of assembling the inner electronic assembly 200 and the cylindrical housing 100 in accordance with the fourth embodiment and that of assembling the inner electronic assembly 200 and the cylindrical housing 100 in accordance with the first embodiment is that the second insulating annular plate 211, in the fourth embodiment, is mounted to the step 2342 of the fourth surge-protection metal annular plate 234, followed by the first signal terminal 202 being moved into the through hole 108 in the cylindrical housing 100 in a direction from the outer-thread portion 106 to the nut portion 102 such that the horizontally-extending portion of the first signal terminal 202 may pass sequentially through the axial through hole 211a in the second insulating annular plate 211 and the axial through hole 234a in the fourth surge-protection metal annular plate 234. Next, the metal sleeve 204 having the first insulating annular plate 206, first water-proof insulating annular plate 208 and first surge-protection metal annular plate 210 mounted into the through hole 204a therein may be moved into the through hole 108 in the cylindrical housing 100 in a direction from the nut portion 102 to the outer-thread portion 106 until the first surge-protection metal annular plate 210 and a rear end of the metal sleeve 204 contact the fourth surge-protection metal annular plate 234 such that the horizontally-extending portion of the first signal terminal 202 may pass sequentially through the axial through hole 210a in the first surge-protection metal annular plate 210, the axial through hole 208a in the first water-proof insulating annular plate 208 and the axial through hole 206a in the first insulating annular plate 206.

In a first case as illustrated in FIG. 9a, the axial through hole 234a in the fourth surge-protection metal annular plate 234 may have the inner diameter substantially equal to that of the axial through hole 210a in the first surge-protection metal annular plate 210. A radial air gap 2341 between an annular surface of the axial through hole 234a in the fourth surge-protection metal annular plate 234 and a cylindrical surface of the first signal terminal 202 may be substantially equal to the first radial air gap 2102.

Alternatively, in a second case as illustrated in FIG. 9b, the axial through hole 234a in the fourth surge-protection metal annular plate 234 may have the inner diameter less than that of the axial through hole 210a in the first surge-protection metal annular plate 210. The difference between the inner diameter of the axial through hole 234a and that of the axial through hole 210a may be between 0.1 mm and 0.9 mm, and preferably between 0.1 mm and 0.3 mm, between 0.2 mm and 0.6 mm or between 0.3 mm and 0.9 mm. A fifth radial air gap 2344 between an annular surface of the axial through hole 234a in the fourth surge-protection metal annular plate 234 and a cylindrical surface of the first signal terminal 202 may be less than the first radial air gap 2102. The difference between the first and fifth air gaps 2102 and 2344 may be between 0.05 mm and 0.45 mm, and preferably between 0.05 mm and 0.15 mm, between 0.1 mm and 0.3 mm or between 0.15 and 0.45 mm.

Alternatively, in a third case as illustrated in FIG. 9c, the axial through hole 234a in the fourth surge-protection metal annular plate 234 may have the inner diameter greater than that of the axial through hole 210a in the first surge-protection metal annular plate 210. The difference between the inner diameter of the axial through hole 234a and that of the axial through hole 210a may be between 0.1 mm and 0.9 mm, and preferably between 0.1 mm and 0.3 mm, between 0.2 mm and 0.6 mm or between 0.3 mm and 0.9 mm. A sixth radial air gap 2346 between an annular surface of the axial through hole 234a in the fourth surge-protection metal annular plate 234 and a cylindrical surface of the first signal terminal 202 may be greater than the first radial air gap 2102. The difference between the first and sixth air gaps 2102 and 2346 may be between 0.05 mm and 0.45 mm, and preferably between 0.05 mm and 0.15 mm, between 0.1 mm and 0.3 mm or between 0.15 and 0.45 mm.

### Fifth Embodiment

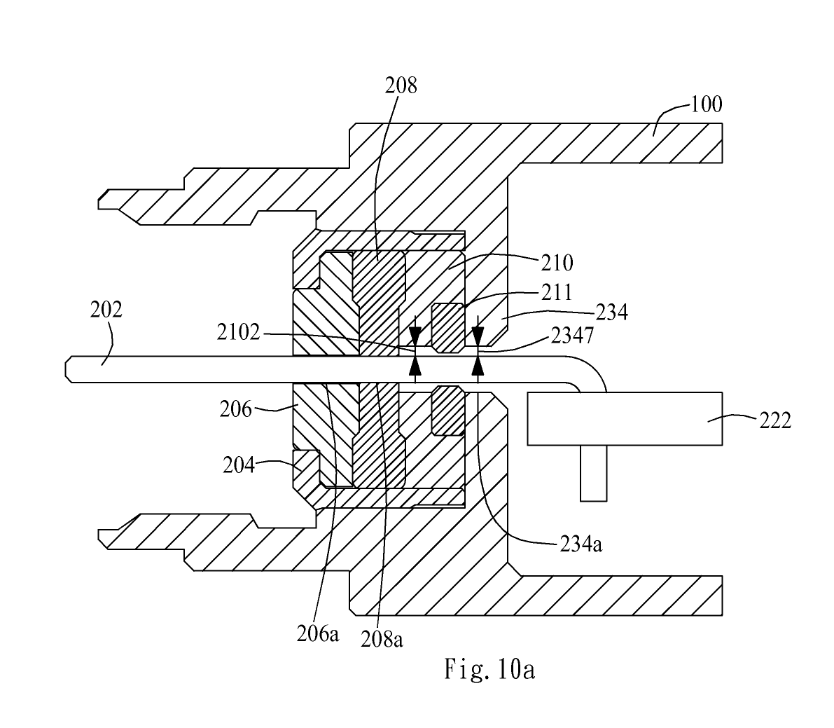

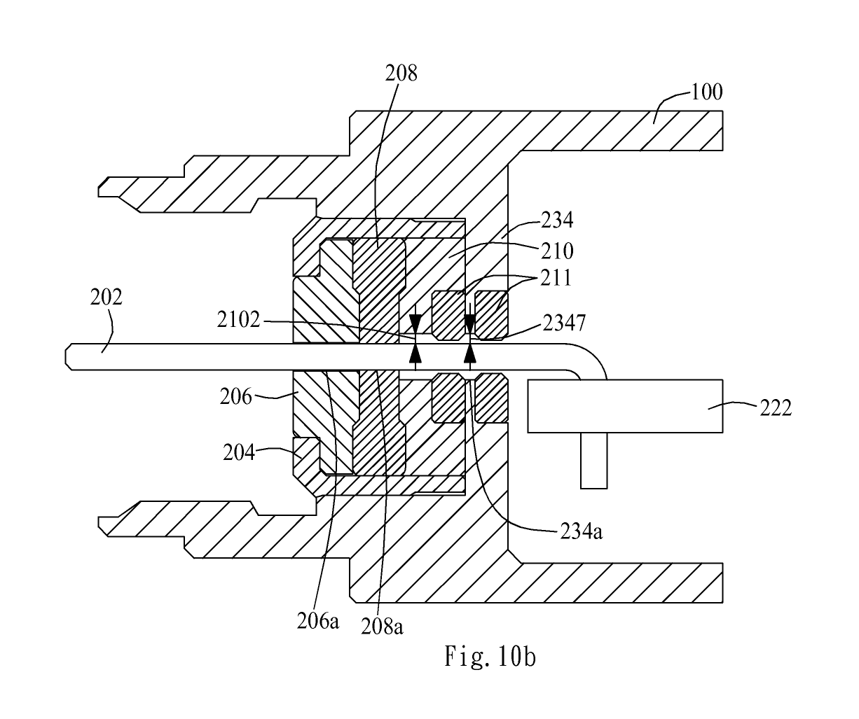

Referring to FIG. 10a, the difference between the fourth and fifth embodiments is that the fourth surge-protection metal annular plate 234 in accordance with the fifth embodiment has no step, like the step 2342 shown in the fourth embodiment, having the second insulating annular plate 211 mounted thereto, but the first surge-protection metal annular plate 210 in accordance with the fifth embodiment has a step, like the step 2101 shown in the first embodiment, having the second insulating annular plate 211 mounted thereto. With regards to the step of assembling the inner electronic assembly 200 and the cylindrical housing 100, after the second insulating annular plate 211 mounted to the step 2101 of the first surge-protection metal annular plate 210, the metal sleeve 204 having the first insulating annular plate 206, first water-proof insulating annular plate 208 and first surge-protection metal annular plate 210 mounted into the through hole 204a therein may be moved into the through hole 108 in the cylindrical housing 100 in a direction from the nut portion 102 to the outer-thread portion 106 until the first surge-protection metal annular plate 210, a rear end of the metal sleeve 204 and the second insulating annular plate 211 contact the fourth surge-protection metal annular plate 234 such that the horizontally-extending portion of the first signal terminal 202 may pass sequentially through the axial through hole 211a in the second insulating annular plate 211, the axial through hole 210a in the first surge-protection metal annular plate 210, the axial through hole 208a in the first water-proof insulating annular plate 208 and the axial through hole 206a in the first insulating annular plate 206. Also, the axial through hole 234a in the fourth surge-protection metal annular plate 234 may have the inner diameter substantially equal to, less than or greater than that of the axial through hole 210a in the first surge-protection metal annular plate 210. A radial air gap 2347 between an annular surface of the axial through hole 234a in the fourth surge-protection metal annular plate 234 and a cylindrical surface of the first signal terminal 202 may be substantially equal to the first radial air gap 2102, or less than or greater than the first radial air gap 2102 with a difference between the radial air gap 2347 and the first radial air gap 2102 being between 0.05 mm and 0.45 mm, and preferably between 0.05 mm and 0.15 mm, between 0.1 mm and 0.3 mm or between 0.15 and 0.45 mm.

Alternatively, the fourth surge-protection metal annular plate 234 having the step 2342 having the second insulating annular plate 211 mounted thereto, as illustrated in the fourth embodiment, may be incorporated into the fifth embodiment as shown in FIG. 10b. Thereby, the two second insulating annular plates 211 may be arranged to stably maintain the radial air gap 2347 and the first radial air gap 2102 and to prevent the first and fourth surge-protection metal annular plates 210 and 234 from contacting the first signal terminal 202 or being too close to the first signal terminal 202.

### Sixth Embodiment

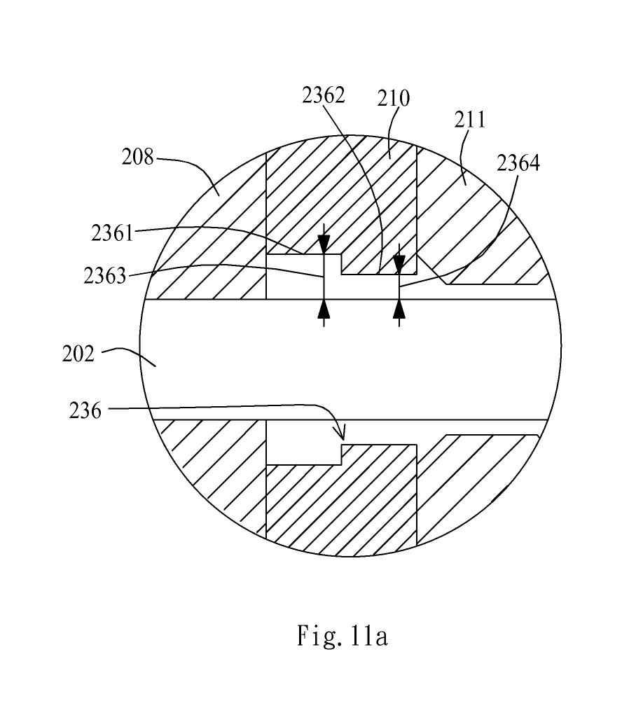

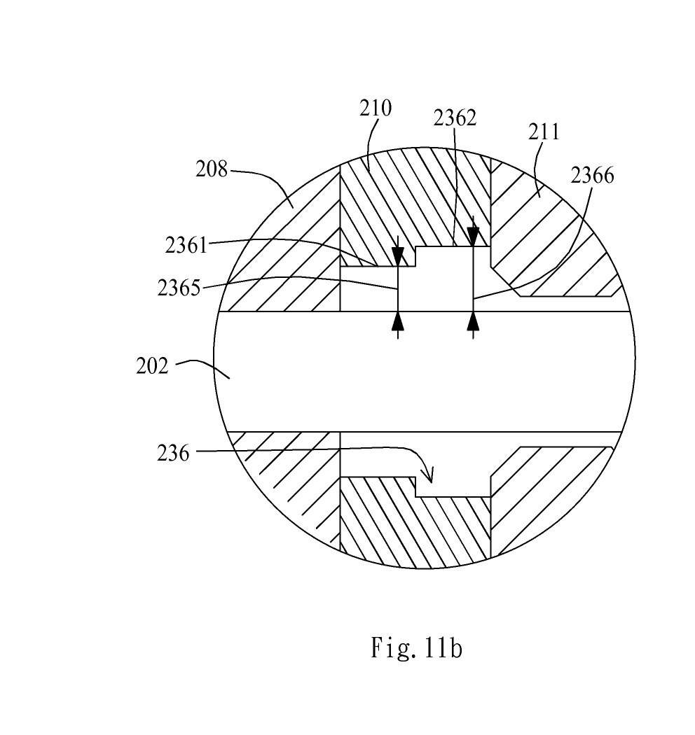

Alternatively, each of the through holes 210a, 216a, 232a and 234a in the respective first, second, third and fourth surge-protection metal annular plates 210, 216, 232 and 234 may have an annular surface with one or more steps. Referring to FIG. 11 a, taking the first surge-protection metal annular plate 210 as an example, the annular surface of the through hole 210a in the first surge-protection metal annular plate 210 may have a step 236 with a front annular surface 2361 and a back annular surface 2362, wherein the front annular surface 2361 has an inner diameter greater than that of the back annular surface 2362 with a difference between the inner diameter of the front annular surface 2361 and the inner diameter of the back annular surface 2362 being between 0.05 mm and 0.45 mm, and preferably between 0.05 mm and 0.15 mm, between 0.1 mm and 0.3 mm or between 0.15 and 0.45 mm. A seventh radial air gap 2363 between the front annular surface 2361 and the first signal terminal 202 may be greater than an eighth radial air gap 2364 between the back annular surface 2362 and the first signal terminal 202 with a difference between the seventh and eighth radial air gaps 2363 and 2364 being between 0.05 mm and 0.45 mm, and preferably between 0.05 mm and 0.15 mm, between 0.1 mm and 0.3 mm or between 0.15 and 0.45 mm, wherein the eighth radial air gap 2364 may be between 0.05 mm and 0.8 mm, and preferably between 0.1 mm and 0.6 mm or between 0.15 mm and 0.5 mm. As mentioned above, each of the third and fourth surge-protection metal annular plates 232 and 234 may have the step 236 with the front annular surface 2361 and the back annular surface 2362 to form the defined seventh radial air gap 2363 between the front annular surface 2361 and the first signal terminal 202 and the defined eighth radial air gap 2364 between the back annular surface 2362 and the first signal terminal 202. Each of the second and third surge-protection metal annular plates 216 and 232 may have the step 236 with the front annular surface 2361 and the back annular surface 2362 to form the defined seventh radial air gap 2363 between the front annular surface 2361 and the second signal terminal 214 and the defined eighth radial air gap 2364 between the front annular surface 2362 and the second signal terminal 214.

Alternatively, referring to FIG. 11b, taking the first surge-protection metal annular plate 210 as an example, the front annular surface 2361 has an inner diameter less than that of the back annular surface 2362 with a difference between the inner diameter of the front annular surface 2361 and the inner diameter of the back annular surface 2362 being between 0.05 mm and 0.45 mm, and preferably between 0.05 mm and 0.15 mm, between 0.1 mm and 0.3 mm or between 0.15 and 0.45 mm. A ninth radial air gap 2365 between the front annular surface 2361 and the first signal terminal 202 may be less than a tenth radial air gap 2366 between the back annular surface 2362 and the first signal terminal 202 with a difference between the ninth and tenth radial air gaps 2365 and 2366 being between 0.05 mm and 0.45 mm, and preferably between 0.05 mm and 0.15 mm, between 0.1 mm and 0.3 mm or between 0.15 and 0.45 mm, wherein the tenth radial air gap 2366 may be between 0.05 mm and 0.8 mm, and preferably between 0.1 mm and 0.6 mm or between 0.15 mm and 0.5 mm. As mentioned above, each of the third and fourth surge-protection metal annular plates 232 and 234 may have the step 236 with the front annular surface 2361 and the back annular surface 2362 to form the defined ninth radial air gap 2365 between the front annular surface 2361 and the first signal terminal 202 and the defined tenth radial air gap 2366 between the back annular surface 2362 and the first signal terminal 202. Each of the second and third surge-protection metal annular plates 216 and 232 may have the step 236 with the front annular surface 2361 and the back annular surface 2362 to form the defined ninth radial air gap 2365 between the front annular surface 2361 and the second signal terminal 214 and the defined tenth radial air gap 2366 between the front annular surface 2362 and the second signal terminal 214.

### Seventh Embodiment

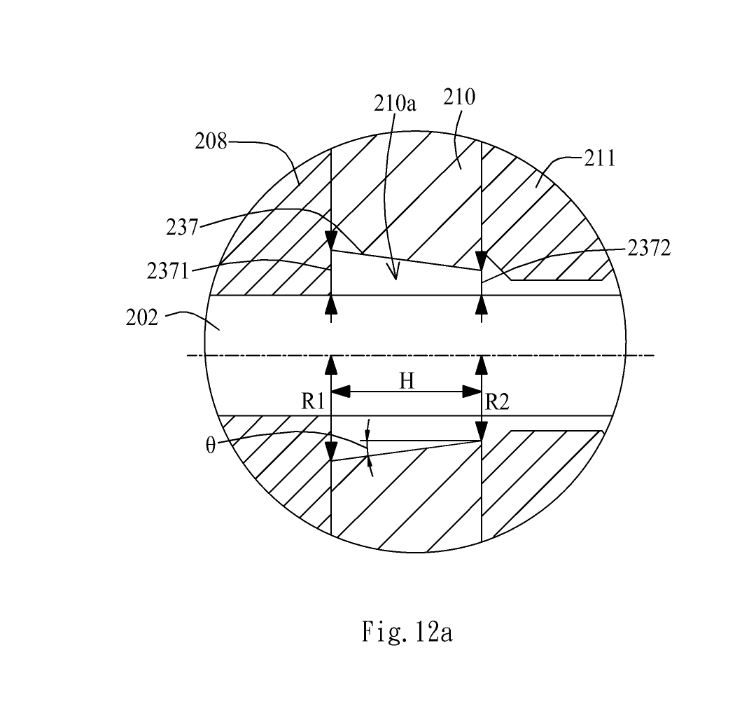

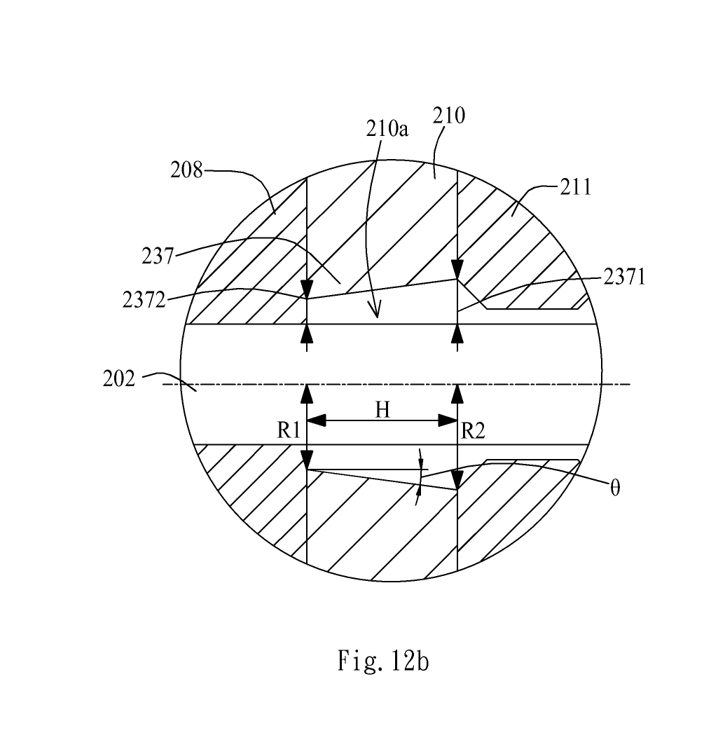

Alternatively, each of the through holes 210a, 216a, 232a and 234a in the respective first, second, third and fourth surge-protection metal annular plates 210, 216, 232 and 234 may have a coned surface. Referring to FIG. 12a, taking the first surge-protection metal annular plate 210 as an example, the through hole 210a in the first surge-protection metal annular plate 210 may have a coned surface 237 with a greatest inner radius R1 at a front end of the axial through hole 210a adjacent to the first water-proof insulating annular plate 208 and a smallest inner radius R2 at a rear end of the axial through hole 210a adjacent to the second insulating annular plate 211. An axial distance H is defined between the greatest inner radius R1 and the smallest inner radius R2. An coned angle θ defined by tan⁻¹ (R1−R2)/H may be between 2 and 45 degrees, and preferably between 2 and 15 degrees, between 5 and 30 degrees or between 8 and 45 degrees. A greatest radial air gap 2371, i.e. eleventh radial air gap, between the coned surface 237 and the first signal terminal 202 is at a front end of the axial through hole 210a adjacent to the first water-proof insulating annular plate 208 and a smallest radial air gap 2372, i.e. twelfth radial air gap, between the coned surface 237 and the first signal terminal 202 is at a rear end of the axial through hole 210a adjacent to the second insulating annular plate 211. A difference between the eleventh and twelfth radial air gaps 2371 and 2372 being between 0.05 mm and 0.45 mm, and preferably between 0.05 mm and 0.15 mm, between 0.1 mm and 0.3 mm or between 0.15 and 0.45 mm. As mentioned above, each of the second, third and fourth surge-protection metal annular plates 216, 232 and 234 may have the coned surface 237 with the greatest inner radius R1 at a front end of the corresponding axial through hole 216a, 232a or 234a and the smallest inner radius R2 at a rear end of the corresponding axial through hole 216a, 232a or 234a so as to form the defined coned angle θ, the defined greatest radial air gap 2371, i.e. eleventh radial air gap, between the coned surface 237 at the front end of the axial through hole 232a or 234a and the first signal terminal 202 or between the coned surface 237 at the front end of the axial through hole 216a or 232a and the second signal terminal 214, the defined smallest radial air gap 2372, i.e. twelfth radial air gap, between the coned surface 237 at the rear end of the axial through hole 232a or 234a and the first signal terminal 202 or between the coned surface 237 at the rear end of the axial through hole 216a or 232a and the second signal terminal 214, and the defined difference between the defined eleventh and twelfth radial air gaps 2371 and 2372.

Alternatively, referring to FIG. 12b, each of the through holes 210a, 216a, 232a and 234a in the respective first, second, third and fourth surge-protection metal annular plates 210, 216, 232 and 234 may have a coned surface with the greatest inner radius R1 at the rear end of the corresponding axial through hole 210a, 216a, 232a or 234a and the smallest inner radius R2 at the front end of the corresponding axial through hole 210a, 216a, 232a or 234a so as to form the defined coned angle θ, the defined greatest radial air gap 2371, i.e. eleventh radial air gap, between the coned surface 237 at the rear end of the axial through hole 210a, 232a or 234a and the first signal terminal 202 or between the coned surface 237 at the rear end of the axial through hole 216a or 232a and the second signal terminal 214, the defined smallest radial air gap 2372, i.e. twelfth radial air gap, between the coned surface 237 at the front end of the axial through hole 210a, 232a or 234a and the first signal terminal 202 or between the coned surface 237 at the front end of the axial through hole 216a or 232a and the second signal terminal 214, and the defined difference between the defined eleventh and twelfth radial air gaps 2371 and 2372.

### Eighth Embodiment

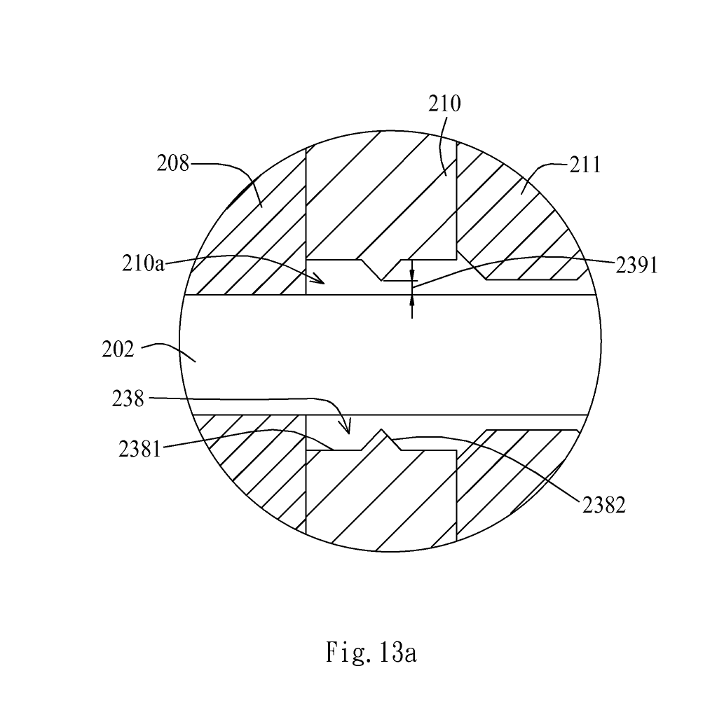

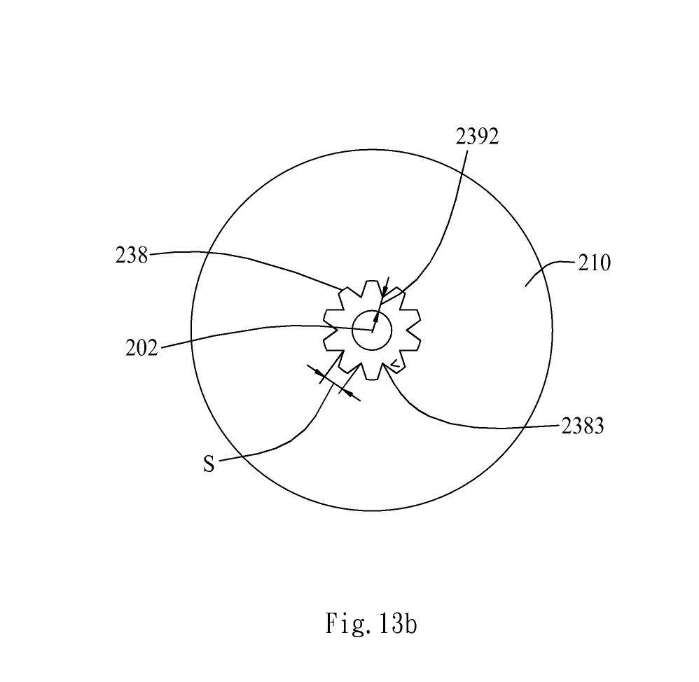

Alternatively, each of the first, second, third and fourth surge-protection metal annular plates 210, 216, 232 and 234 may have one or more bumps protruding from an annular surface of the through holes 210a, 216a, 232a and 234a in the respective first, second, third and fourth surge-protection metal annular plates 210, 216, 232 and 234. Referring to FIG. 13a, taking the first surge-protection metal annular plate 210 as an example, the first surge-protection metal annular plate 210 may have an annular bump 2382 annularly protruding from an annular surface 2381 of the through hole 210a in the first surge-protection metal annular plate 210. The annular bump 2382 has the smallest inner diameter less than an inner diameter of the annular surface 2381 of the through hole 210a, wherein a difference between the smallest inner diameter of the annular bump 2382 and the inner diameter of the annular surface 2381 of the through hole 210a may be between 0.03 mm and 0.45 mm, and preferably between 0.03 mm and 0.1 mm, between 0.1 mm and 0.3 mm or between 0.15 and 0.45 mm. A thirteenth radial air gap 2391 between a tip of the annular bump 2382 and the first signal terminal 202 may be between 0.05 mm and 0.8 mm, and preferably between 0.1 mm and 0.6 mm or between 0.15 mm and 0.5 mm. The annular bump 2382 may have the surge current to be guided in focus such that the surge current may be efficiently guided. Alternatively, a plurality of the annular bump 2382 may be provided to annularly protrude in parallel from the annular surface 2381 of the through hole 210a. In this case, the annular bump 2382 has a cross section shaped like a triangle, but may have another cross section shaped like a rectangle or a semi-circle. As mentioned above, each of the third and fourth surge-protection metal annular plates 232 and 234 may have the annular bump 2382, or a plurality of the annular bump 2382, annularly protruding from, or annularly protruding in parallel from, an annular surface of the corresponding through hole 232a or 234a so as to form the defined thirteenth radial air gap 2391 between the tip of the annular bump 2382 and the first signal terminal 202. Each of the second and third surge-protection metal annular plates 216 and 232 may have the annular bump 2382, or a plurality of the annular bump 2382, annularly protruding from, or annularly protruding in parallel from, an annular surface of the corresponding through hole 216a or 232a so as to form the defined thirteenth radial air gap between the tip of the annular bump 2382 and the second signal terminal 214.

Alternatively, referring to FIG. 13b, taking the first surge-protection metal annular plate 210 as an example, the first surge-protection metal annular plate 210 may have multiple conical bumps 2383 protruding from an annular surface 238 of the through hole 210a in the first surge-protection metal annular plate 210, wherein the conical bumps 2383 may be arranged in a ring around the horizontally-extending portion of the first signal terminal 202. A distance s between tips of neighboring two of the conical bumps 2383 may be between 0.03 mm and 0.3 mm, and preferably between 0.03 mm and 0.1 mm, 0.05 and 0.15 mm or between 0.1 and 0.3 mm. A fourteenth radial air gap 2392 between a tip of one of the conical bumps 2383 and the first signal terminal 202 may be between 0.05 mm and 0.8 mm, and preferably between 0.1 mm and 0.6 mm or between 0.15 mm and 0.5 mm. Alternatively, the conical bumps 2383 may be arranged in multiple parallel rings around the horizontally-extending portion of the first signal terminal 202. In this case, each of the conical bumps 2383 has a cross section shaped like a triangle, but may have another cross section shaped like a rectangle or a semi-circle. As mentioned above, each of the third and fourth surge-protection metal annular plates 232 and 234 may have the conical bumps 2383 protruding from an annular surface of the corresponding through hole 232a or 234a in a ring or multiple parallel rings around the first signal terminal 202 so as to form the defined fourteenth radial air gap 2392 between the tip of one of the conical bumps 2383 and the first signal terminal 202 and the defined distance s between tips of neighboring two of the conical bumps 2383. Each of the second and third surge-protection metal annular plates 216 and 232 may have the conical bumps 2383 protruding from an annular surface of the corresponding through hole 216a or 232a in a ring or multiple parallel rings around the second signal terminal 214 so as to form the defined fourteenth radial air gap 2392 between the tip of one of the conical bumps 2383 and the second signal terminal 214 and the defined distance s between tips of neighboring two of the conical bumps 2383.

### Ninth Embodiment

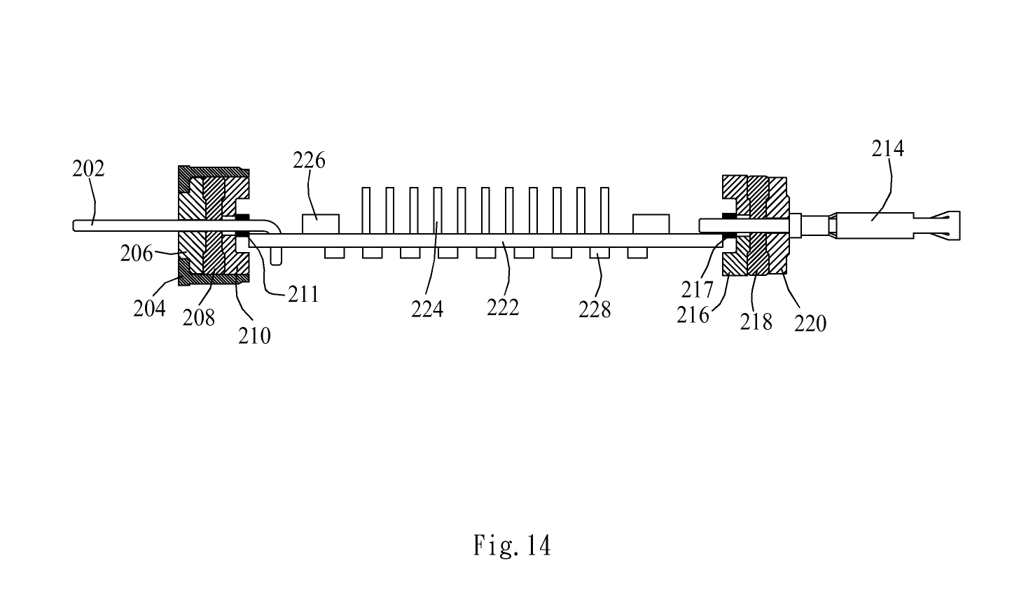

Alternatively, the second and third insulating annular plates 211 and 217 mounted respectively to the steps 2101 and 2161 of the first and second surge-protection metal annular plates 210 and 216 may be replaced with first and second insulating tubes 311 and 317 respectively as shown in FIG. 14. The first and second insulating tubes 311 and 317 may be made of a material composing the second and third insulating annular plates 211 and 217. The order of assembling the first and second insulating tubes 311 and 317 for the inner electronic assembly 200 may be different from that of assembling the second and third insulating annular plates 211 and 217 for the inner electronic assembly 200. Referring to FIG. 14, taking the first surge-protection metal annular plate 210 as an example, with regard to the first discharging structure, the first insulating tube 311 may be sleeved in position on the horizontally-extending portion of the first signal terminal 202, and then the horizontally-extending portion of the first signal terminal 202 may be inserted sequentially into the axial through hole 210a in the first surge-protection metal annular plate 210, the axial through hole 208a in the first water-proof insulating annular plate 208, and the axial through hole 206a in the first insulating annular plate 206 after the first insulating annular plate 206, first water-proof insulating annular plate 208 and first surge-protection metal annular plate 210 are mounted into the through hole 204a in the metal sleeve 204 until the first surge-protection metal annular plate 210 has the step 2101 contacting the first insulating tube 311. Thereby, the first radial air gap 2101 may be tightly sealed by the first insulating tube 311 and first water-proof insulating annular plate 208. With regard to the second discharging structure, after the second signal terminal 214 has the metal wire or rod to be inserted sequentially into the axial through hole 220a in the fourth insulating annular plate 220, the axial through hole 218a in the second water-proof insulating annular plate 218 and the axial through hole 216a in the second surge-protection metal annular plate 216 in position, the second insulating tube 317 is moved to be sleeved on the second signal terminal 214 until the second insulating tube 317 contacts the step 2161 of the second surge-protection metal annular plate 216. Thereby, the second radial air gap 2162 may be tightly sealed by the second insulating tube 317 and second water-proof insulating annular plate 218.

For the third embodiment as shown in FIGS. 8a-8c, with regard to the first discharging structure, the second insulating annular plate 211 may be replaced with the first insulating tube 311 to be sleeved on the horizontally-extending portion of the first signal terminal 202 and contact the step 2101 of the first surge-protection metal annular plate 210 such that the adjacent radial air gaps 2102 and 2321 as illustrated in FIG. 8a, the adjacent radial air gaps 2102 and 2322 as illustrated in FIG. 8b and the adjacent radial air gaps 2102 and 2324 as illustrated in FIG. 8c may be tightly sealed by the first insulating tube 311 and first water-proof insulating annular plate 208. With regard to the second discharging structure, the third insulating annular plate 217 may be replaced with the second insulating tube 317 to be sleeved on the second signal terminal 214 and contact the step 2161 of the second surge-protection metal annular plate 216 such that the adjacent radial air gaps 2162 and 2321, the adjacent radial air gaps 2162 and 2322 and the adjacent radial air gaps 2162 and 2324 as illustrated in FIG. 8c may be tightly sealed by the second insulating tube 317 and second water-proof insulating annular plate 218.

For the fourth embodiment as shown in FIGS. 9a-9c, with regard to the first discharging structure, the second insulating annular plate 211 may be replaced with the first insulating tube 311 to be sleeved on the horizontally-extending portion of the first signal terminal 202 and contact the step 2342 of the fourth surge-protection metal annular plate 234 such that the adjacent radial air gaps 2102 and 2341 as illustrated in FIG. 9a, the adjacent radial air gaps 2102 and 2344 as illustrated in FIG. 9b and the adjacent radial air gaps 2102 and 2346 as illustrated in FIG. 9c may be tightly sealed by the first insulating tube 311 and first water-proof insulating annular plate 208.

For the fifth embodiment as shown in FIG. 10a, with regard to the first discharging structure, the second insulating annular plate 211 may be replaced with the first insulating tube 311 to be sleeved on the horizontally-extending portion of the first signal terminal 202 and contact the step 2101 of the first surge-protection metal annular plate 210 such that the radial air gap 2102 may be tightly sealed by the first insulating tube 311 and first water-proof insulating annular plate 208. Referring to FIG. 10b, each of the second insulating annular plates 211 may be replaced with the first insulating tube 311 to be sleeved on the horizontally-extending portion of the first signal terminal 202. The front one of the first insulating tubes 311 may contact the step 2101 of the first surge-protection metal annular plate 210 such that the radial air gap 2102 may be tightly sealed by the front one of the first insulating tubes 311 and first water-proof insulating annular plate 208. The front one of the first insulating tubes 311 may contact a front side of the fourth surge-protection metal annular plate 234 to seal a front end of the radial air gap 2347. The rear one of the first insulating tubes 311 may contact the step 2342 of the fourth surge-protection metal annular plate 234 such that the radial air gap 2347 may be tightly sealed by the front and back ones of the first insulating tubes 311.

Alternatively, for the above embodiments that the second or third insulating annular plate 211 or 217 is replaced with the first insulating tube 311 or 317, each of the through holes 210a, 216a, 232a and 234a in the respective first, second, third and fourth surge-protection metal annular plates 210, 216, 232 and 234 may have an annular surface with the step 236 as illustrated in FIGS. 11a and 11b in the sixth embodiment, with the coned surface 237 as illustrated in FIGS. 12a and 12b in the seventh embodiment or with one or more bumps 2382 or 2383 as illustrated in FIGS. 13a and 13b in the eighth embodiment.

### Tenth Embodiment

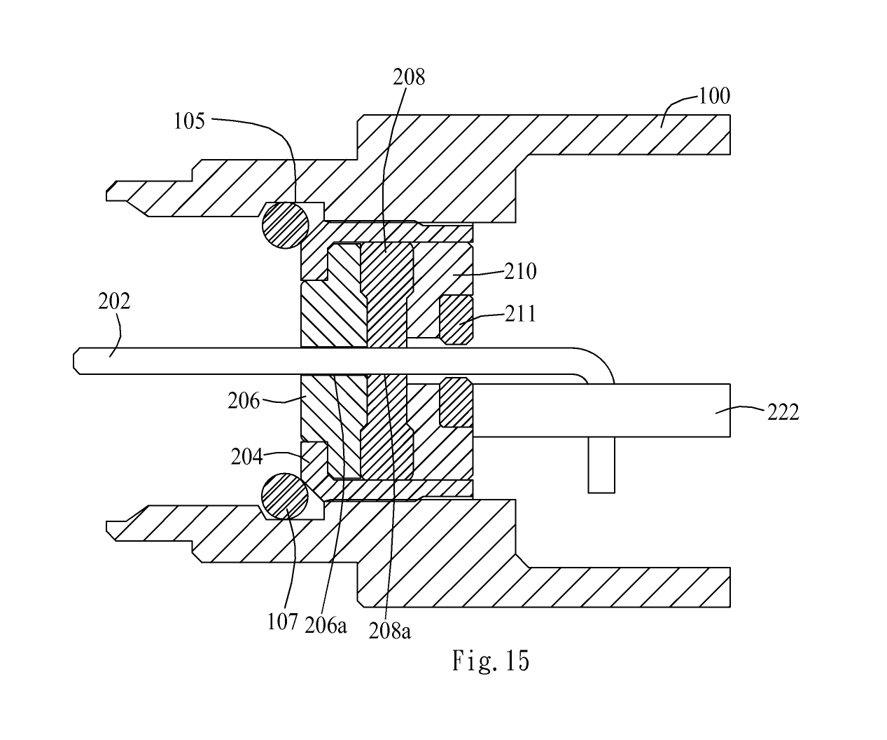

Alternatively, referring to FIG. 15, an annular grove 105 may be formed from an annular surface of the through hole 108 and adjacent to the nut portion 102 of the cylindrical housing 100. The annular grove 105 may accommodate a water-proof rubber ring 107 such that the electronic device may have enhanced water proof.

The scope of protection is limited solely by the claims, and such scope is intended and should be interpreted to be as broad as is consistent with the ordinary meaning of the language that is used in the claims when interpreted in light of this specification and the prosecution history that follows, and to encompass all structural and functional equivalents thereof.

What is claimed is:

1. A signal transmission device comprising:
a first metal plate; and
a first metal rod passing through a first hole in said first metal plate, wherein a first radial gap between said first metal rod and a first annular surface of said first hole is between 0.1 millimeters and 0.6 millimeters, wherein an electric current is configured to be discharged from said first metal rod to said first metal plate when a voltage difference between said first metal plate and said first metal rod is greater than or equal to 1 kV.

2. The signal transmission device of claim 1, wherein said first annular surface axially extends a first distance at a first diameter, wherein said first distance is between 0.5 millimeters and 2 millimeters.

3. The signal transmission device of claim 2, wherein a second annular surface of said first hole axially extends a second distance at a second diameter, wherein said second diameter is greater than said first diameter.

4. The signal transmission device of claim 3 further comprising a polymer ring plate sleeved on said first metal rod, wherein said polymer ring plate has a peripheral sidewall contacting said second annular surface.

5. The signal transmission device of claim 1, wherein said first radial gap is between 0.2 millimeters and 0.3 millimeters.

6. The signal transmission device of claim 1 further comprising a second metal plate and a second metal rod passing through a second hole in said second metal plate, wherein a second radial gap between said second metal rod and a second annular surface of said second hole is between 0.1 millimeters and 0.6 millimeters.

7. The signal transmission device of claim 1 further comprising a metal sleeve sleeved on a peripheral sidewall of said first metal plate.

8. The signal transmission device of claim 1, wherein said first metal plate comprises a protrusion protruding from said first annular surface, wherein a second radial gap between a tip of said protrusion and said first metal rod is between 0.1 millimeters and 0.6 millimeters.

9. The signal transmission device of claim 1 further comprising a second radial gap between said first metal rod and a second annular surface of said first hole is between 0.1 millimeters and 0.6 millimeters, wherein said second annular surface has a diameter smaller than that of said first annular surface.

10. The signal transmission device of claim 1, wherein said first metal plate is electrically grounded and said first metal rod is configured for signal transmission.

11. The signal transmission device of claim 1 further comprising a circuit board connected to said first metal rod, wherein said circuit board comprises a first polymer layer, a patterned metal layer on said first polymer layer, and a second polymer layer on said first polymer layer and said patterned metal layer, wherein said patterned metal layer is connected to said first metal rod.

12. The signal transmission device of claim 11 further comprising an integral shell body accommodating said circuit board, first metal rod and first metal plate.

13. The signal transmission device of claim 11 further comprising a coil on said circuit board.

14. The signal transmission device of claim 11 further comprising a resistor on said circuit board.

15. The signal transmission device of claim 11 further comprising a capacitor on said circuit board.

16. The signal transmission device of claim 11 further comprising a polymer ring plate sleeved on said first metal rod, wherein said polymer ring plate is at a front side of said first metal plate, and said circuit board is at a back side of said first metal plate.

17. The signal transmission device of claim 11 further comprising a metal sheet mounted to a first edge of said circuit board, wherein said metal sheet has a portion upwards extending from said first edge of said circuit board arranged in a horizontal level, wherein said metal plate is at a second edge of said circuit board, wherein said second edge is adjacent to said first edge.

18. The signal transmission device of claim 11 further comprising a second metal plate sleeved on said first metal rod, wherein said second metal plate is at a front side of said first metal plate, and said circuit board is at a back side of said first metal plate, wherein said first metal rod passes through a second hole in said second metal plate, wherein a second radial gap between said first metal rod and a second annular surface of said second hole is between 0.1 millimeters and 0.6 millimeters.

19. The signal transmission device of claim 18, wherein said second annular surface has a diameter greater than that of said first annular surface.

20. The signal transmission device of claim 18, wherein said second annular surface has a diameter smaller than that of said first annular surface.
